(19) United States
(12) Patent Application Publication
(10) Pub. No.: US 2012/0072638 A1
(43) Pub. Date: Mar. 22, 2012

(54) SINGLE STEP PROCESSING OF MEMORY MAPPED ACCESSES IN A HYPERVISOR

(75) Inventors: J. Alan Grubb, North Wales, PA (US); John Landis, Brighton, MN (US); Bryan Thompson, Coon Rapids, MN (US); James R. Hunter, Chadds Ford, PA (US)

(73) Assignee: Unisys Corp., Blue Bell, PA (US)

(21) Appl. No.: 12/883,465

(22) Filed: Sep. 16, 2010

(51) Int. Cl. G06F 12/08

(52) U.S. Cl. 711/6; 711/E12.016

(57) ABSTRACT

Trapping and/or processing of read/write accesses to hardware devices represented to the host through a memory mapped space may be performed without knowledge of the processor's instruction set or semantics of the processor's instructions. A single step routine may be executed to recognize page faults occurring from read/write accesses to emulated memory pages and causing the guest to retry the operation on a single step buffer. The hypervisor may perform post-operation processing on the single step buffer after the guest retries and completes the read or write access. For example, on a read request, the single step routine may place the guest value in the single step buffer for reading by the guest on a retry operation. On a write request, the single step routine may direct the guest to retry the write operation into the single step buffer. After the retry operation the single step routine may read the guest value from the single step buffer and place the guest value in a register of an appropriate emulated system.

### TECHNICAL FIELD

The instant disclosure relates to a computer system. More specifically, the a system for processing memory mapped accesses is disclosed.

### BACKGROUND

Virtualization has many advantages for hardware and software developers. For example, virtualization allows applications and even operating systems/environments to be moved from one physical computing device to another. However, rapid rate of change in the technology industry may cause a virtual machine to attempt to leverage or exploit hardware-level and/or software level calls which are not directly emulated in the virtual environment. For example, most virtualization technology vendors have recognized that it may not be efficient or cost-effective to emulate within a virtualization environment every potential instruction set supported by a given microprocessor or other such device.

Conventionally, the developers of the virtualization technologies have observed specific operating systems and applications as those operating systems and applications ran on physical hardware, and identified the microprocessor instructions which are most frequently called. These most frequently used instruction calls were then implemented as part of that vendor's virtualization environment. This approach creates the possibility that an application or newer operating system will attempt to leverage a microprocessor instruction that is not directly supported by the virtualization environment. Such calls can frequently result in unsupported errors which may crash the entire system.

For example, in a conventional system a hypervisor traps and processes all read or write accesses to hardware devices that are represented to the host system through memory mapped space. Upon trapping the read or write access the hypervisor provides instruction emulation logic to complete the read or write access. Thus, in order to process the accesses, the hypervisor uses specific knowledge of the processor instruction set or the semantics of the processor's instructions. Storing processor instruction sets or semantics of the processor's instructions increases the complexity of the hypervisor. Additionally, if instructions are added to an instruction set of a processor the hypervisor may not have knowledge of the new instruction set. Thus, there is a need to trap and process read or write accesses without knowledge of the processor's instruction set or semantics of the processor's instructions.

### SUMMARY

According to one embodiment, a method includes determining an access request from a guest to a memory page of a memory device has created a page fault. The method also includes passing page fault information to a processor for decoding. The method further includes mapping the memory page to a single step buffer. The method also includes directing the guest to repeat the access request to the single step buffer.

According to another embodiment, a computer program product includes a computer-readable medium having code to determine an access request from a guest to a memory page of a memory device has created a page fault. The medium also includes code to pass page fault information to a processor for decoding. The medium further includes code to map the memory page to a single step buffer. The medium also includes code to direct the guest to repeat the access request to the single step buffer.

According to a further embodiment, an apparatus includes a memory device. The apparatus also includes a processor coupled to the memory device. The processor is configured to determine an access request from a guest to a memory page of the memory device has created a page fault. The processor is also configured to pass page fault information to the at least one processor for decoding. The processor is further configured to map the memory page to a single step buffer. The processor is also configured to direct the guest to repeat the access request to the single step buffer.

### BRIEF DESCRIPTION OF THE DRAWINGS

For a more complete understanding of the disclosed system and methods, reference is now made to the following descriptions taken in conjunction with the accompanying drawings.

FIG. 1 is a schematic block diagram illustrating one embodiment of an exemplary system for processing memory mapped access.

FIG. 2 is a schematic block diagram illustrating one embodiment of an exemplary computer system that may be used in accordance with certain embodiments of the system for processing memory mapped access.

FIG. 3 is a table illustrating a memory paging table according to one embodiment.

FIG. 4 is a flow chart illustrating trapping memory page accesses in a hypervisor according to one embodiment.

FIG. 5 is a flow chart illustrating handling page faults in a hypervisor according to one embodiment.

### DETAILED DESCRIPTION

The instant disclosure recognizes that virtualization using specific information about the processor instruction sets may be problematic, as the rate of change within the technology industry means that the virtual machines may attempt to leverage or exploit hardware-level and/or software level calls which are not directly emulated in the virtual environment. In high-availability and/or mission-critical applications, such as, without limitation, systems supporting emergency services or banking applications, such crashes can have a significant economic and even human impact, and thus the likelihood of such crashes should be reduced to the greatest extent possible. According to one embodiment, a “single step” mode may be implemented for a microprocessor by which read or write accesses may be trapped and/or processed regardless of whether an access is formally supported by a particular virtualization environment, or hypervisor. A hypervisor virtualizes various hardware entities such as virtual APICs, virtual IOAPICs to a guest environment being hosted by the hypervisor.

Trapping and/or processing of read or write accesses to hardware devices represented to the host through a memory mapped space may be performed in a processor's single step mode without knowledge of the processor's instruction set or semantics of the processor's instructions. According to one embodiment, a single step routine may be executed to recognize page faults occurring from read or write accesses to emulated memory pages and cause the guest to retry the operation on a single step buffer. The hypervisor may perform post-operation processing on the single step buffer after the guest retries and completes the read or write access. For example, on a read request, the single step routine may place the guest value in the single step buffer for reading by the guest on a retry operation. On a write request, the single step routine may direct the guest to retry the write operation into the single step buffer. After the retry operation the single step routine may read the guest value from the single step buffer and place the guest value in a register of an appropriate emulated system.

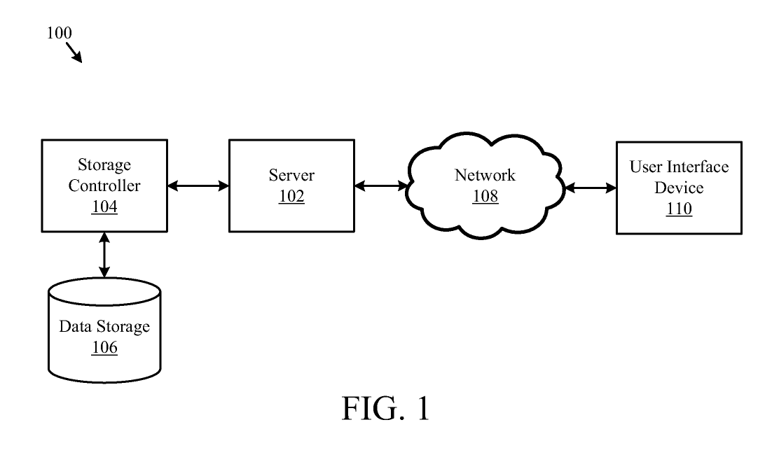

FIG. 1 illustrates one embodiment of a system 100 for operating a hypervisor. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer; a laptop computer; a Personal Digital Assistant (PDA) or tablet computer, a smartphone or other mobile communication device, or organizer device having access to the network 108. In a further embodiment, the user interface device 110 may access the Internet or other wide area or local area network to access a web application or web service hosted by the server 102 and provide a user interface for enabling a user to enter or receive information.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another. The data storage device 106 may include a hard disk, including hard disks arranged in a Redundant Array of Independent Disks (RAID) array, a tape storage drive comprising a magnetic tape data storage device, an optical storage device, or the like.

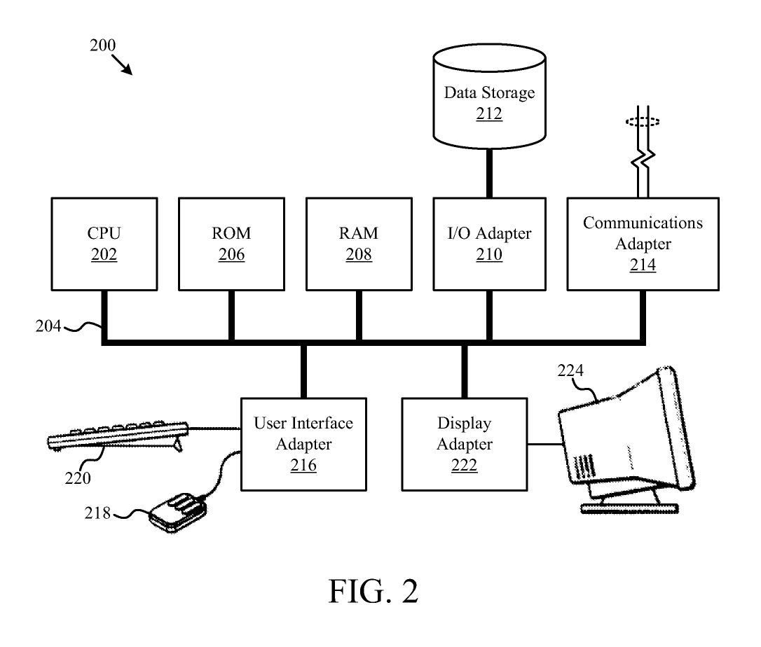

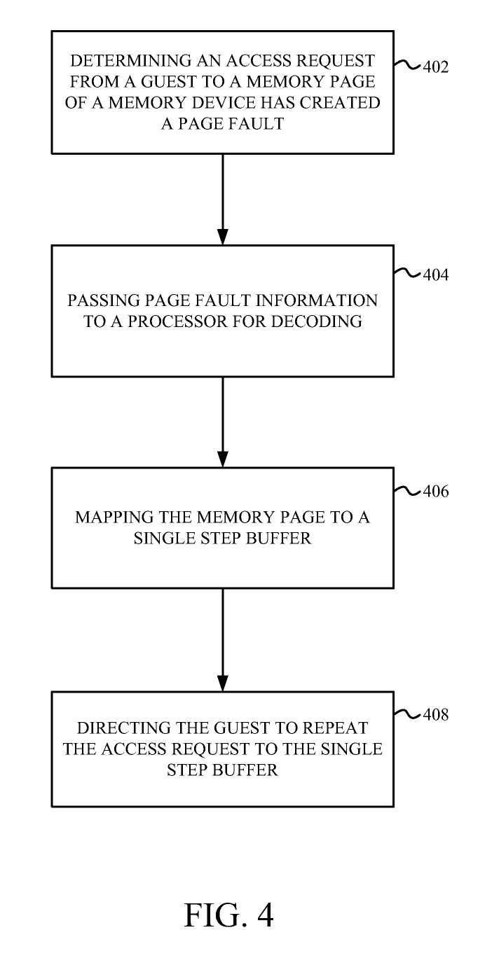

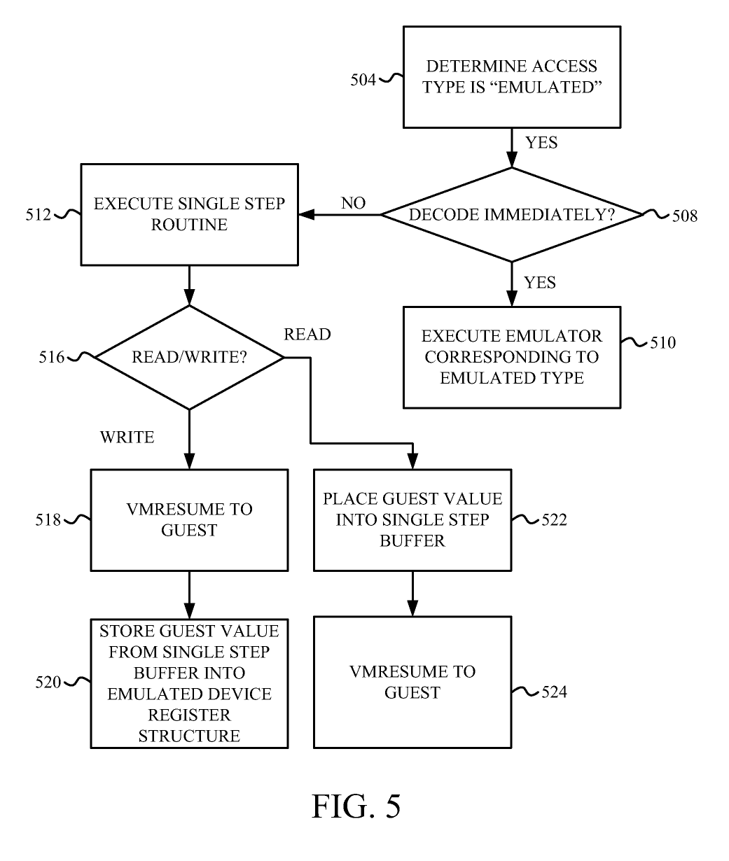

FIG. 2 illustrates a computer system 200 adapted according to certain embodiments of the server 102 and/or the user interface device 110. The central processing unit (“CPU”) 202 is coupled to the system bus 204. The CPU 202 may be a general purpose CPU or microprocessor, graphics processing unit (“GPU”), microcontroller, or the like. The present embodiments are not restricted by the architecture of the CPU 202. The CPU 202 may execute the various logical instructions, such as the methods of FIGS. 4 and 5, according to the present embodiments.

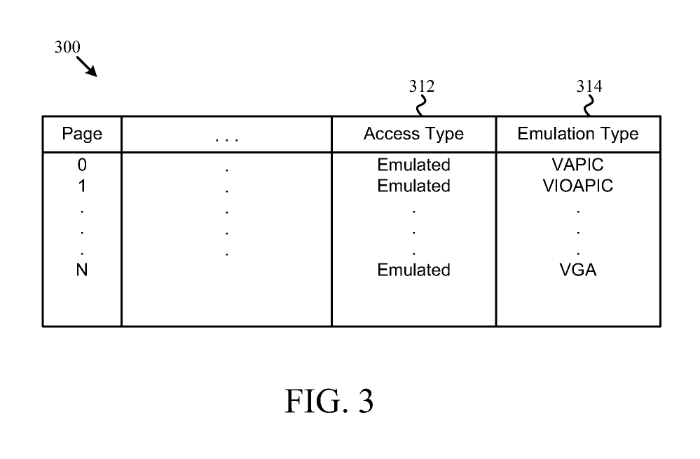

The computer system 200 also may include random access memory (RAM) 208, which may be SRAM, DRAM, SDRAM, or the like. The computer system 200 may utilize RAM 208 to store the various data structures used by a software application such as a hypervisor or guest. According to one embodiment, the RAM 208 may store memory tables, such as the table illustrated in FIG. 3. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface.

The I/O adapter 210 may connect one or more storage devices 212, such as one or more of a hard drive, a compact disk (CD) drive, a floppy disk drive, and a tape drive, to the computer system 200. The communications adapter 214 may be adapted to couple the computer system 200 to the network 108, which may be one or more of a LAN, WAN, and/or the Internet. The user interface adapter 216 couples user input devices, such as a keyboard 220 and a pointing device 218, to the computer system 200. The display adapter 222 may be driven by the CPU 202 to control the display on the display device 224.

The applications of the instant disclosure are not limited to the architecture of computer system 200. Rather the computer system 200 is provided as an example of one type of computing device that may be adapted to perform the functions of a server 102 and/or the user interface device 110. For example, any suitable device may be utilized including without limitation, including personal data assistants (PDAs), tablet computers, smartphones, computer game consoles, and multi-processor servers. Moreover, the systems and methods of the instant disclosure may be implemented on application specific integrated circuits (ASIC), very large scale integrated (VLSI) circuits, or other circuitry. Persons of ordinary skill in the art may utilize any number of suitable structures capable of executing logical operations according to the described embodiments or equivalents thereof.

FIG. 3 is a table illustrating a memory paging table according to one embodiment. A table 300 includes, for each memory page, an access type field 312 and an emulation type field 314. The access type field 312 may be set to “Emulated” for any page of memory for which a hypervisor will provide emulation assistance. For memory pages of access type “emulated,” the emulation type field 314 provides information regarding the type of emulated device with which the memory page is associated. For example, and without limitation, the emulation type field may be “VAPIC,” “VIOAPIC,” “WDT,” or “VGA.”

According to one embodiment, pages having an access type of “Emulated” have page table presence bits left off. When the presence bits are missing guest accesses to these pages may create page faults. When a page fault is created VMEXITs may occur to the hypervisor. When a VMEXIT is received at the hypervisor with an indication that the page fault was from an emulated memory page, the hypervisor may handle the page fault through the use of a single step buffer.

FIG. 4 is a flow chart illustrating trapping memory page accesses in a hypervisor according to one embodiment. At block 402 a system determines than an access request from a guest to a memory page of a memory device has created a page fault. At block 404 the system passes the page fault information to a processor for decoding. At block 406 the system maps the memory page to a single step buffer. At block 408 the system directs the guest to repeat the access request to the single step buffer.

FIG. 5 is a flow chart illustrating handling page faults in a hypervisor according to one embodiment. When a page fault occurs a page fault handler may check the page fault information for an access type of the memory page. At block 504 the page fault handler determines the access type is “emulated.” When the memory page is an emulated page, page fault information is used to decode the instruction. According to one embodiment, the page fault information includes fault address, fault address page offset, and/or if the instruction is a read or write request. According to one embodiment, the instruction may be determined to be a read or write request according to a VMCS field. At block 508 a decision is made to immediately decode the instruction.

If the decision is to immediately decode the instruction, at block 510 an emulator corresponding to the emulated type of the memory page is executed. The emulator may allow the guest to directly read or write a register value. For example, if the emulation type of the memory page is VAPIC the VapicHandler routine is executed. Similarly if the emulation type of the memory page is VIOAPIC the VioapicHandler routine is executed, or if the emulation type of the memory page is VGA the Bochs emulator is executed.

If the decision is not to immediately decode the instruction at block 512 a single step routine is executed. The single step routine may receive information about the page fault such as, for example, page address, page address offset, and read/write selection, from a PageFaultHandler routine. The single step routine of block 512 may call PointPageTableAtSSBuf, which receives the page fault address and directs a Shadow Page Table entry to a single step buffer. The single step routine of block 512 may also set a single step flag and save page fault information in a virtual central processing unit (VCPU).

At block 516 the single step routine determines if the page fault occurred during a read operation or a write operation. If a write operation caused the page fault, a VMRESUME may occur to the guest at block 518. The guest then retries the write operation to a temporary hypervisor-owned single step buffer mapped through a shadow page table to the requested memory page. At block 520 the guest value is read from the single step buffer and placed into a register structure of an emulated device corresponding to the emulated type of the memory page. According to one embodiment, a second single step routine is executed in response to a second VMEXIT operation to perform block 520 and place the guest value into the emulated device register structure.

If a read operation is determined to cause the page fault at block 516, the value requested by the guest in the read operation is placed in a temporary hypervisor-owned single step buffer mapped through a shadow page table to the requested memory page at block 522. At block 524 a VMRESUME may occur to the guest to continue executing operations in a single step mode. The guest then retries the read operation and reads the value from the single step buffer. According to one embodiment, after the read operation a subsequent VMEXIT occurs to perform post-processing after the read operation. The post-processing may include turning off the single step mode of operation. The VMRESUME operations of block 524 and block 518 indicate to the guest to continue executing operations, no longer in a single step mode, that follow the operation causing the page fault.

According to one embodiment, the VMRESUME operations for single step mode are identified by an injector as the highest priority injection event according to a single step flag. Execution of the single step routine may be indicated by a Guest EFLAG/RFLAG register TF bit. The single step routine may save the original Guest EFLAGs/RFLAGs value, in addition to other information such as the Guest DR7, set a VCPU Single Step flag, and then set the TF bit in the Guest EFLAGs/RFLAGs copy, which will be in effect when the VMRESUME occurs to the guest at block 524 and block 518. According to one embodiment, setting the TF bit causes a debug exception interrupt to occur, and to generate an associated VMEXIT operation, after the guest accesses the single step buffer.

A debug exception routine may perform post-processing for the single step routine when a VMEXIT operation occurs. The debug exception may recognize a single step flag to indicate if post-processing for the single step routine should be performed. When the single step flag is set, a routine, such as SingleStepFinish routine, is executed to perform post-operation-retry processing. Post-operation-retry processing may include invalidating a Shadow Page Table entry for the memory page causing the page fault, restoring the original Guest EFLAGs/RFLAGs value and/or the Guest DR7, and resetting a VCPU Single Step flag. According to one embodiment, the debug exception routine performs block 520 if the operation is a write access.

After the single step routine and post-processing are complete, a VMRESUME may occur to the guest to resume the guest in normal mode. If any additional injection events exist, an injector may be called before the VMRESUME operation to return to normal mode is executed.

Although not illustrated, FIGS. 4 and 5 may include blocks for a ensuring the memory page is present or that a page fault handler has made the memory page present in the guest page tables before beginning the single step routine.

As described above, the embodiments of the present disclosure allow a single step routine to trap and/or process memory accesses to hardware devices represented to the host through a memory mapped space. The single step routine may trap and process read and write requests without specific knowledge of the processor instruction set or the semantics of the processor's instructions. Additionally, without using specific knowledge of the instruction set allows the hypervisor to adapt as instructions sets for a processor are changed. According to one embodiment, standard Intel page fault mechanisms may trap memory mapped read and write accesses to the hypervisor. Additionally, the Intel debugger single step feature may be used by the hypervisor to undo redirection to the single step buffer.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
determining an access request from a guest to a memory page of a memory device has created a page fault;
passing page fault information to a processor for decoding;
mapping the memory page to a single step buffer; and
directing the guest to repeat the access request to the single step buffer.

2. The method of claim 1, further comprising when the access request is a read request storing a read value into the single step buffer before directing the guest to repeat the access request.

3. The method of claim 1, in which the access request is to a hardware device represented as the memory page.

4. The method of claim 1, further comprising when the access request is a write request:
reading a value from the single step buffer after directing the guest to repeat the access request; and
executing an emulator to place the value in a register structure of the emulator.

5. The method of claim 4, in which the emulator is at least one of a VAPIC emulator, a VIOAPIC emulator, a WDT emulator, and a VGA emulator.

6. The method of claim 1, in which the step of directing the guest to repeat the access request comprises returning execution to the guest by executing a VMRESUME operation.

7. The method of claim 1, in which the step of mapping the memory page to the single step buffer maps through a shadow page table entry.

8. A computer program product, comprising:
a computer-readable medium comprising:
code to determine an access request from a guest to a memory page of a memory device has created a page fault;
code to pass page fault information to a processor for decoding;
code to map the memory page to a single step buffer; and
code to direct the guest to repeat the access request to the single step buffer.

9. The computer program product of claim 8, in which the medium further comprises code to, when the access request is a read request, store a read value into the single step buffer before directing the guest to repeat the access request.

10. The computer program product of claim 8, in which the access request is to a hardware device represented as the memory page.

11. The computer program product of claim 8, in which the medium further comprises:
code to read, when the access request is a write request, a value from the single step buffer after directing the guest to repeat the access request; and
code to execute, when the access request is a write request, an emulator to place the value in a register structure of the emulator.

12. The computer program product of claim 11, in which the emulator is at least one of a VAPIC emulator, a VIOAPIC emulator, a WDT emulator, and a VGA emulator.

13. The computer program product of claim 8, in which the code to direct the guest to repeat the access request returns control to the guest by executing a VMRESUME operation.

14. The computer program product of claim 8, in which the code to map the memory page to the single step buffer maps through a shadow page table entry.

15. An apparatus, comprising:
a memory device; and
at least one processor coupled to the memory device, in which the at least one processor is configured:
to determine an access request from a guest to a memory page of the memory device has created a page fault;
to pass page fault information to the at least one processor for decoding;
to map the memory page to a single step buffer; and
to direct the guest to repeat the access request to the single step buffer.

16. The apparatus of claim 15, in which the at least one processor is further configured to, when the access request is a read request, store a read value into the single step buffer before directing the guest to repeat the access request.

17. The apparatus of claim 15, in which the access request is to a hardware device represented as the memory page.

18. The apparatus of claim 15, in which the at least one processor is further configured:
to read, when the access request is a write request, a value from the single step buffer after directing the guest to repeat the access request; and
to execute, when the access request is a write request, an emulator to place the value in a register structure of the emulator.

19. The apparatus of claim 15, in which the at least one processor directs the guest to repeat the access request by returning control to the guest by executing a VMRESUME operation.

20. The apparatus of claim 15, in which the at least one processor maps the memory page to the single step buffer through a shadow page table entry.
